(19) United States
(12) Patent Application Publication
(10) Pub. No.: US 2015/0199592 A1
(43) Pub. Date: Jul. 16, 2015

(54) CONTOUR-BASED CLASSIFICATION OF OBJECTS

(71) Applicant: Microsoft Corporation, Redmond, WA (US)

(72) Inventors: David Kim, Cambridge (GB); Cem Keskin, Cambridge (GB); Jamie Daniel Joseph Shotton, Cambridge (GB); Shahram Izadi, Cambridge (GB)

(21) Appl. No.: 14/154,368

(22) Filed: Jan. 14, 2014

(51) Int. Cl. G06K 9/62; G06K 9/46

(52) U.S. Cl. CPC G06K 9/6267; G06K 9/4604

(57) ABSTRACT

Described herein is a contour-based method of classifying an item, such as a physical object or pattern. In an example method, a one-dimensional (1D) contour signal is received for an object. The one-dimensional contour signal comprises a series of 1D or multi-dimensional data points (e.g. 3D data points) that represent the contour (or outline of a silhouette) of the object. This 1D contour can be unwrapped to form a line, unlike for example, a two-dimensional signal such as an image. Some or all of the data points in the 1D contour signal are individually classified using a classifier which uses contour-based features. The individual classifications are then aggregated to classify the object and/or part(s) thereof. In various examples, the object is an object depicted in an image.

### BACKGROUND

Gesture recognition for human-computer interaction, computer gaming and other applications is difficult to achieve with accuracy and in real-time. Many gestures, such as those made using human hands are detailed and difficult to distinguish from one another. In particular, it is difficult to accurately classify the position and parts of a hand depicted in an image. Also, equipment used to capture images of a hand may be noisy and error prone.

Previous approaches have analyzed each pixel of the image depicting the hand. While this often produces relatively accurate results it requires a significant amount of time and processing power.

The embodiments described below are not limited to implementations which solve any or all of the disadvantages of known classification systems.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Described herein is a contour-based method of classifying an item, such as a physical object or pattern. In an example method, a one-dimensional (1D) contour signal is received for an object. The one-dimensional contour signal comprises a series of 1D or multi-dimensional data points (e.g. 3D data points) that represent the contour (or outline of a silhouette) of the object. This 1D contour can be unwrapped to form a line, unlike for example, a two-dimensional signal such as an image. Some or all of the data points in the 1D contour signal are individually classified using a classifier which uses contour-based features. The individual classifications are then aggregated to classify the object and/or part(s) thereof. In various examples, the object is an object depicted in an image.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a classification system for classifying objects in an image;

FIG. 2 is a schematic diagram of the capture system and computing-based device of FIG. 1;

FIG. 3 is a schematic diagram of the data output by the capture system and computing-based device of FIG. 2;

FIG. 4 is a flow diagram of a method of classifying an object in an image using a contour signal of the object;

FIG. 5 is a schematic diagram illustrating how to locate data points of a contour signal that are a predetermined distance from another data point;

FIG. 6 is a schematic diagram illustrating determining the convex hull of a contour signal;

FIG. 7 is a flow diagram of method of classifying an object using a random decision forest;

FIG. 8 is a schematic diagram of an apparatus for generating training data for a random decision forest;

FIG. 9 is a schematic diagram of a random decision forest;

FIG. 10 is a flow diagram of a method of training a random decision forest;

FIG. 11 is a flow diagram of a method of classifying a contour data point using a random decision forest; and

FIG. 12 illustrates an exemplary computing-based device in which embodiments of the systems and methods described herein may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in an image classification system (i.e. a system to classify 3D objects depicted in an image), the system described herein is provided as an example and not a limitation. As those skilled in the art will appreciate, the present examples are suitable for application in a variety of different types of classification systems. In particular, those of skill in the art will appreciate that the present object classification systems and methods may be used to classify any item (i.e. physical object or pattern that can be represented by a one-dimensional (1D) contour (i.e. a series of connected points). Examples of an item include, in additional to any physical object, a handwritten signature, a driving route or pattern of motion of a physical object. Although in the examples described below, the series of connected points are a series of connected points in space, in other examples they may be a sequence of inertial measurement units (e.g. as generated when a user moves their phone around in the air in a particular pattern).

As described above, a previous approach to classification of objects in an image has been to classify each pixel of the image using a classifier and then accumulate or otherwise combine the results of each pixel classification to generate a final classification. This approach has been shown to produce relatively accurate results, but it is computationally intense since each pixel of the image is analyzed. Accordingly, there is a need for an accurate, but less computationally intensive method for classifying objects in an image.

Described herein is a classification system which classifies an object from a one-dimensional contour of the object. The term “one-dimensional contour” is used herein to mean the edge or line that defines or bounds the object (e.g. when the object is viewed as a silhouette). The one-dimensional contour is represented as a series (or list) of one-dimensional or multi-dimensional (e.g. 2D, 3D, 4D, etc) data points that when connected form the contour and which can be unwrapped to form a line, unlike for example, a two-dimensional signal such as an image. In various examples, the 1D contour may be a series (or set) of discrete points (e.g. as defined by their (x,y,z) co-ordinate for a 3D example) and in other examples, the 1D contour may be a perhaps more sparse series of discrete points with mathematical functions which define how adjacent points are connected (e.g. using Bezier curves or spline interpolation). The series of points may be referred to herein as the 1D contour signal. The system described herein classifies an object by independently classifying each of at least a subset of the points of the 1D contour signal using contour-based features (i.e. only features of the 1D contour itself).

The classification system described herein significantly reduces the computational complexity over previous systems that analyzed each and every pixel of the image since only the pixels forming the 1D contour (or data related thereto) are analyzed during the classification. In some cases this may reduce the number of pixels analyzed from around 200,000 to around 2,000. This allows the classification to be executed on a device, such as a mobile phone, with a low power embedded processor. In light of the significant reduction in the data that is analyzed it is surprising that test results have shown that similar accuracies may be achieved with such a classification system as compared to a classification system that analyzed each pixel of an image.

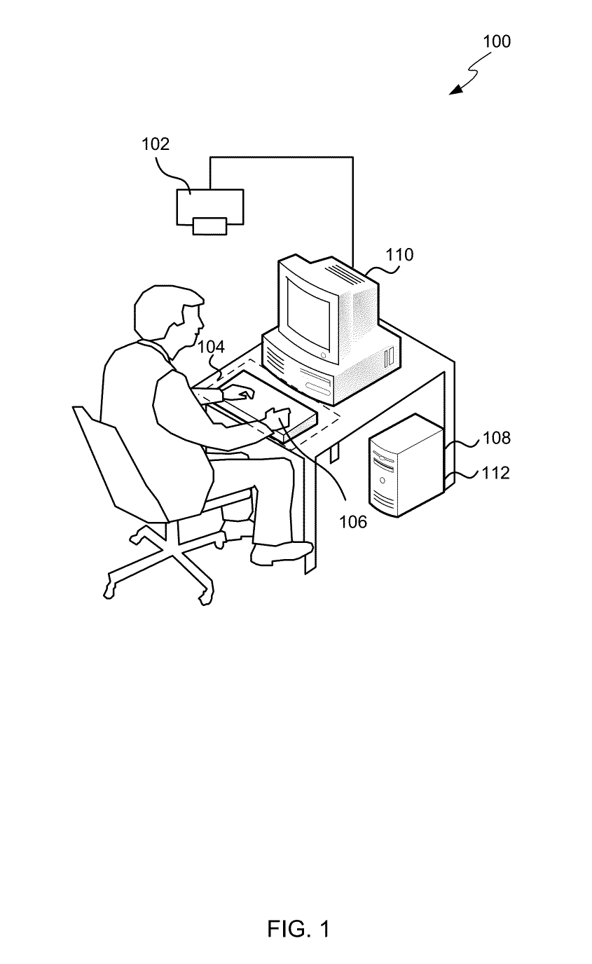

Reference is now made to FIG. 1, which illustrates an example classification system 100 for classifying an object in an image using a one-dimensional contour of the object. In this example, the system 100 comprises a capture device 102 arranged to capture one or more images of a scene 104 comprising an object 106; and a computing-based device 108 in communication with the capture device 102 configured to generate a one-dimensional contour of the object 106 from the image(s), and to classify the object from the one-dimensional contour.

In FIG. 1, the capture device 102 is mounted on a display screen 110 above and pointing downward at the scene 104. However, this is one example only. Other locations for the capture device 102 may be used such as on the desktop looking upwards or other suitable locations.

The computing-based device 108 shown in FIG. 1 is a traditional desktop computer with a separate processor component 112 and display screen 110; however, the methods and systems described herein may equally be applied to computing-based devices 108 wherein the processor component 112 and display screen 110 are integrated such as in a laptop computer, tablet computer or smart phone.

Although the object 106 of FIG. 1 is a human hand, a person of skill in the art will appreciate that the methods and systems described herein may be equally applied to any other object in the scene 104 and the classification system described herein may be used to classify multiple objects in the scene (e.g. a retroreflector and an object which partially occludes the retroreflector).

Although the classification system 100 of FIG. 1 comprises a single capture device 102, the methods and principles described herein may be equally applied to classification systems with multiple capture devices 102. Furthermore, although the description of FIG. 1 refers to the capture device 102 capturing an image, it will be appreciated that other input modalities may alternatively be used (e.g. capturing pen strokes on a tablet computer).

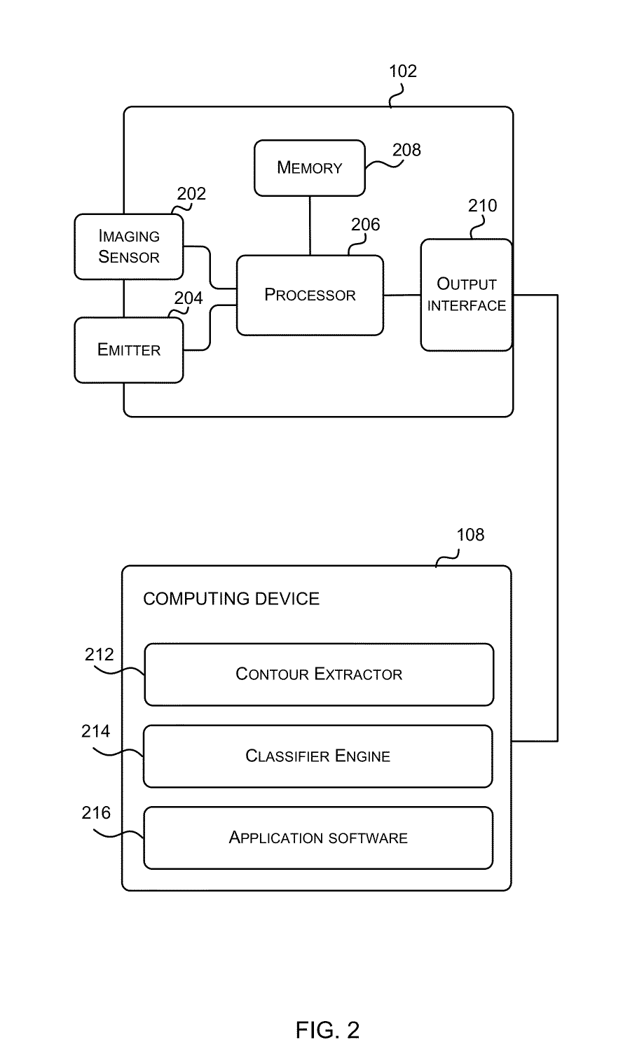

Reference is now made to FIG. 2, which illustrates a schematic diagram of a capture device 102 that may be used in the system 100 of FIG. 1.

The capture device 102 comprises at least one imaging sensor 202 for capturing images of the scene 104 comprising the object 106. The imaging sensor 202 may be any one or more of a stereo camera, a depth camera, an RGB camera, and an imaging sensor capturing or producing silhouette images where a silhouette image depicts the profile of an object.

In some cases, the imaging sensor 202 may be in the form of two or more physically separated cameras that view the scene 104 from different angles, such that visual stereo data is obtained that can be resolved to generate depth information.

The capture device 102 may also comprise an emitter 204 arranged to illuminate the scene in such a manner that depth information can be ascertained by the imaging sensor 202.

The capture device 102 may also comprise at least one processor 206, which is in communication with the imaging sensor 202 (e.g. camera) and the emitter 204 (if present). The processor 206 may be a general purpose microprocessor or a specialized signal/image processor. The processor 206 is arranged to execute instructions to control the imaging sensor 202 and emitter 204 (if present) to capture depth images. The processor 206 may optionally be arranged to perform processing on these images and signals, as outlined in more detail below.

The capture device 102 may also include memory 208 arranged to store the instructions for execution by the processor 206, images or frames captured by the imaging sensor 202, or any suitable information, images or the like. In some examples, the memory 208 can include random access memory (RAM), read only memory (ROM), cache, Flash memory, a hard disk, or any other suitable storage component. The memory 208 can be a separate component in communication with the processor 206 or integrated into the processor 206.

The capture device 102 may also include an output interface 210 in communication with the processor 206. The output interface 210 is arranged to provide the image data to the computing-based device 108 via a communication link. The communication link can be, for example, a wired connection (e.g. USB™, Firewire™, Ethernet™ or similar) and/or a wireless connection (e.g. WiFi™, Bluetooth™ or similar). In other examples, the output interface 210 can interface with one or more communication networks (e.g. the Internet) and provide data to the computing-based device 102 via these networks.

The computing-based device 108 may comprise a contour extractor 212 that is configured to generate a one-dimensional contour of the object 106 in the image data received from the capture device 102. As described above, the one-dimensional contour comprises a series of one or multi-dimensional (e.g. 3D) data points that when connected form the contour. For example, in some cases each data point may comprise the x, y and z co-ordinates of the corresponding pixel in the image. In other cases each data point may comprise the x and y co-ordinates of the pixel and another parameter, such as time or speed. Both these examples use 3D data points.

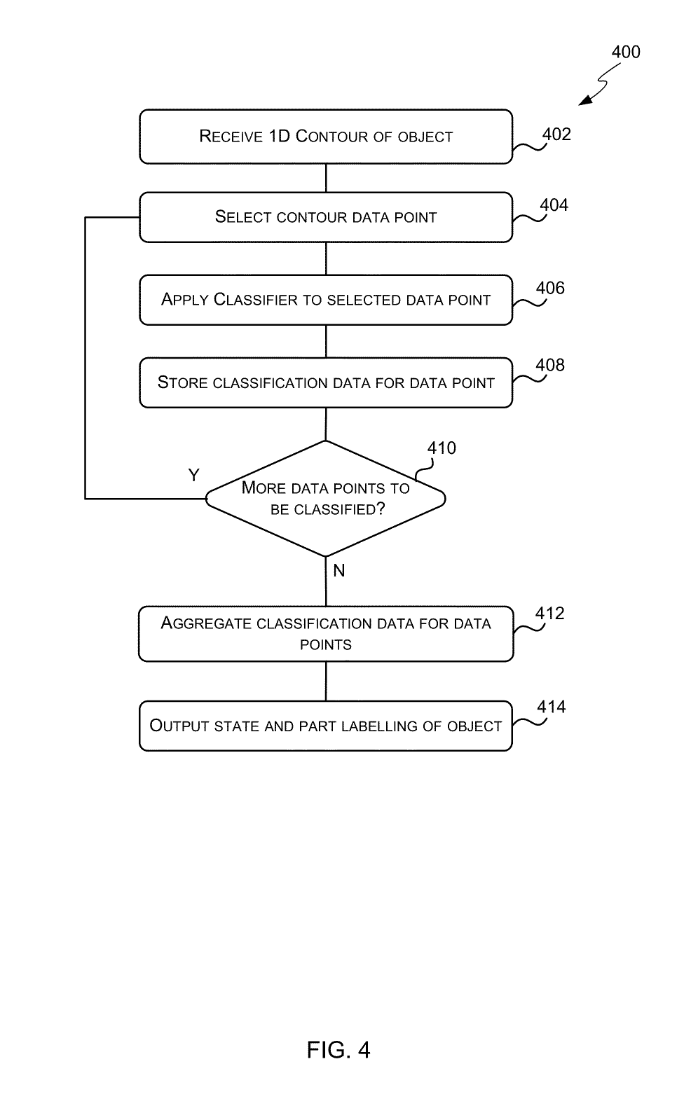

The one-dimensional contour is then used by a classifier engine 214 to classify the object. Specifically, the classifier engine 214 classifies each of a plurality of the points of the one-dimensional contour using contour-based features (i.e. only features of the 1D contour itself). Where the object is a hand (as shown in FIG. 1), the classifier engine 214 may be configured to classify each contour data point as either a salient hand part (e.g. fingertips, wrist and forearm and implicitly the palm) and/or as a hand state (e.g. palm up, palm down, fist up or pointing or combinations thereof). An example method for classifying an object which may be executed by the classifier engine 214 is described with reference to FIG. 4.

Application software 216 may also be executed on the computing-based device 108 which may be controlled by the output of the classifier engine 214 (e.g. the detected classification (e.g. hand pose and state)).

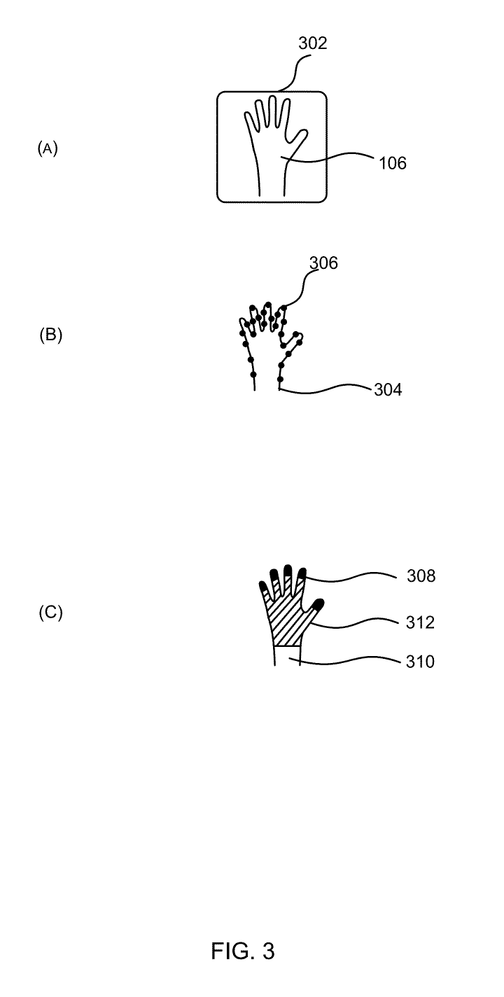

Reference is now made to FIG. 3 which illustrates the flow of data through the classification system of FIGS. 1 and 2. FIG. 3A illustrates an example image 302 produced by the capture device 102 of FIG. 1. The image 302 is of the scene 104 of FIG. 1 and comprises the object 106 (e.g. hand) to be classified. As described above, the capture device 102 provides the image 302 (or images) to the computing-based device 108.

The contour extractor 212 of the computing-based device 108 then uses the image data to generate a one-dimensional contour 304 of the object 106. As shown in FIG. 3B, the one-dimensional contour 304 comprises a series of one or multi-dimensional data points 306 that when connected form the 1D contour 304 (e.g. an outline or silhouette of the object). For example, in some cases each data point comprises the x, y and z co-ordinates of the corresponding pixel in the image. Once the one-dimensional contour 304 has been generated it is provided to the classifier engine 214.

The classifier engine 214 then uses the one-dimensional contour 304 to classify the object 106 (e.g. hand). In some cases classification may comprise assigning one or more labels to the object or parts thereof. The labels used may vary according to the application domain. Where the object is a hand (as shown in FIG. 3), the classification may comprise assigning a hand shape label and/or hand part label(s) to the hand. For example, as shown in FIG. 3C the classifier engine 214 may label the fingertips 308 with one label value, the wrist 310 with a second label value and the remaining parts of the hand 312 with a third label value.

Reference is now made to FIG. 4 which is a flow diagram of an example method 400 for classifying an object using a one-dimensional contour signal. The method 400 is described as being carried out by the classifier engine 214 of FIG. 2, however, in other examples all or part of this method 400 may be carried out by one or more other components.

At block 402 the classifier engine 214 receives a one-dimensional contour of an object (also referred to herein as a one-dimensional contour signal). The one-dimensional contour signal may be represented by the function X such that X(s) indicates the data for point s on the contour. As described above, in some examples the data for each point of the 1D contour may be the one-dimensional (x), two-dimensional (x, y) or three-dimensional (x, y, z) co-ordinates of the point. In other examples, the data for each point may be a combination of co-ordinates and another parameter such as time, speed, Inertial Measurement Unit (IMU) data (e.g. acceleration), velocity (e.g. of a car driving around a bend), pressure (e.g. of a stylus on a tablet screen), etc. Once the classifier engine 214 receives the 1D contour signal the method 400 proceeds to block 404.

At block 404 the classifier engine 214 selects a data point from the received 1D contour signal to be classified. In some examples, the classifier engine 214 is configured to classify each data point of the 1D contour signal. In these examples the first time the classifier engine 214 executes this block it may select the first data point in the signal and subsequent times it executes this block it may select the next data point in the 1D contour signal. In other examples, however, the classifier engine 214 may be configured to classify only a subset of the data points in the 1D contour signal. In these examples, the classifier engine may use other criteria to select data points for classification. For example, the classifier engine 214 may only classify every second data point. Once the classifier engine 214 has selected a contour data point to be classified, the method 400 proceeds to block 406.

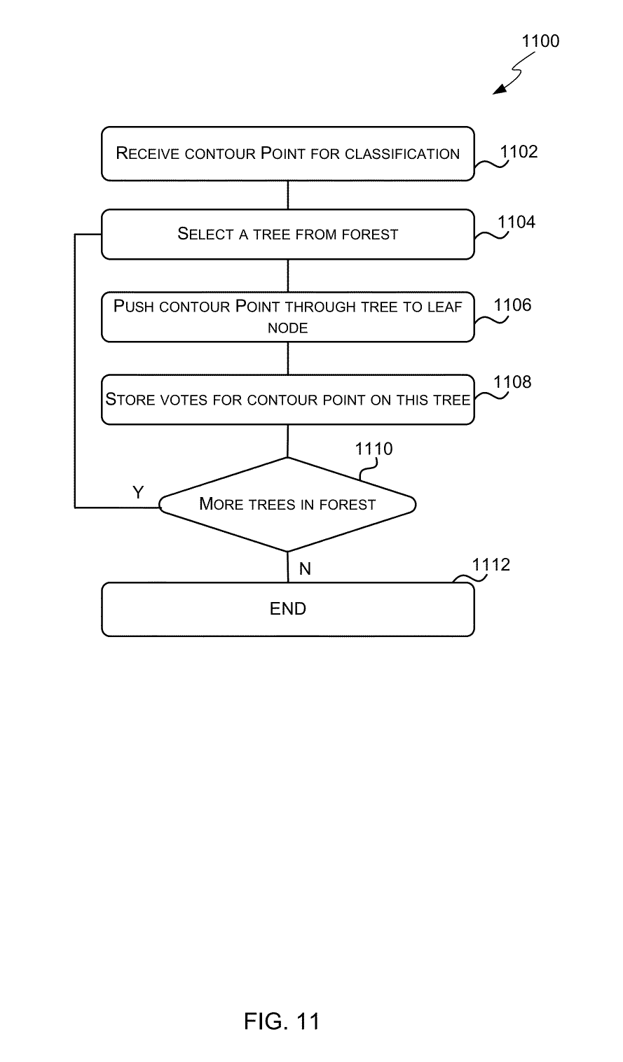

At block 406 the classifier engine 214 applies a classifier to the selected data point to classify the selected data point (e.g. as described in more detail below with reference to FIG. 11). As described above, classification may comprise assigning a label to the object and/or one or more parts of the object. Where the object is a hand, classification may comprise assigning a state label to the object and/or a part label to one or more parts of the hand. For example, in some cases the classifier may associate the selected data point with two class labels y^{s} and y^{f}, where y^{s} is a hand shape/state label (i.e. pointing, pinching, grasping or open hand) and y^{f} is a fingertip label (i.e. index, thumb or non-fingertip). The classifier may also generate probability information for each label that indicates the likelihood the label is accurate or correct. The probability information may in the form of a histogram. The combination of the label(s) and the probability information is referred to herein as the classification data for the selected data point.

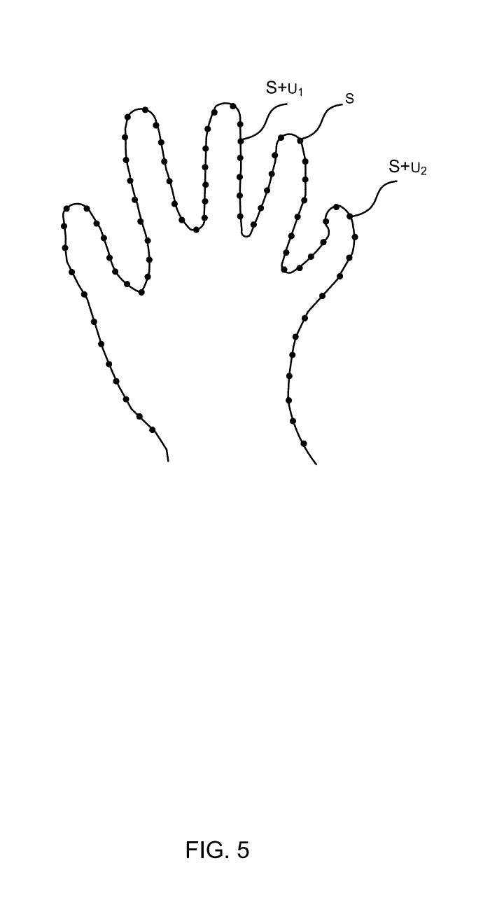

In some examples, the selected data point is classified (i.e. assigned one or more labels) by comparing features of contour data points around, or related to, the selected data point. For example, as illustrated in FIG. 5, the classifier engine 204 may select a first data point s+u₁ a first predetermined distance (u₁) along the 1D contour from the selected data point s and a second data point s+u₂ a second predetermined distance (u₂) along the 1D contour from the selected data point s. In some cases one of the distances may be set to zero so that one of the points used for analysis is the selected point itself and in various examples, more than two data points around the selected data point may be used.

To locate a point a predetermined distance along the 1D contour from the selected point s the classifier engine 214 may analyze each data point from the selected data point s until it locates a data point that is the predetermined distance (or within a threshold of the predetermined distance) along the 1D contour from the selected point s. In other examples, the classifier engine 214 may perform a binary search of the data points along the 1D contour to locate the data point.

As described above, the 1D contour signal is represented by a series of data points. In some examples the data points may be considered to wrap around (i.e. such that the last data point in the series may be considered to be connected to the first data point in the series) so when the classifier engine 214 is attempting to classify a data point at, or near, the end of the series the classifier engine 214 may locate a data point that is a predetermined distance from the data point of interest by analyzing the data points at the beginning of the series. In other examples, the data points may not be considered to wrap around. In these example, when the classifier engine 214 is attempting to classify a data point at, or near, the end of the series and there are no more data points in the series that are at the predetermined distance from the data point of interest, the classifier engine 214 may consider the desired data point to have a null or default value or to have the same value as the last data point in the series.

To simplify the identification of data points that are predetermined distances from another data point, in some examples, upon receiving a 1D contour signal the classifier engine may re-sample the received 1D contour signal to produce a modified 1D contour signal that has data points a fixed unit apart (e.g. 1 mm) Then when it comes to identifying data points that are a fixed distance from the selected data point the classifier engine 214 can jump a fixed number of points in the modified 1D contour signal. For example, if the modified 1D contour signal has data points every 1 mm and the classifier engine 214 is attempting to locate the data point that is 5 mm from the selected data point s then the classifier engine 214 only needs to jump to point s+5.

In some examples, instead of identifying contour data points that are predetermined distances along the 1D contour from the selected data point the classifier engine 214 may identify data points that are related to the selected data point using other criteria. For example, the classifier engine 214 may identify contour data points that are a predetermined angle, relative to the tangent of the 1D contour, (e.g. 5 degrees) from the selected data point. By using angular differences instead of differences, the classification becomes rotation invariant (i.e. the classification given to an object or part thereof is the same irrespective of its global rotational orientation). In further examples, contour data points may be identified by moving (or walking) along the 1D contour until a specific curvature or a minimum/maximum curvature is reached. For temporal signals (i.e. for signals where time is one of the dimensions in a multi-dimensional data point), contour data points may be identified which are a predetermined temporal distance along the 1D contour from the selected data point.

In order that the classification may be depth invariant (i.e. such that the classification is performed in the same way irrespective of whether the object is closer to the capture device 102 in FIG. 1 and hence appears larger in the captured image or further away from the capture device 102 and hence appears smaller in the captured image) where a predetermined distance is used it may be a real world distance (which may also be described as a world space or global distance). The term ‘real world distance’ or ‘global distance’ is used herein to refer to a distance in the actual scene captured by the image capture device 102 in FIG. 1 rather than a distance within the captured image itself For example, where a hand is closer to the image capture device, the length of the first finger will be larger in the image than in a second image captured when the hand was further away from the image capture device. So, if the predetermined distance is a “within image” distance the effect of moving the predetermined distance along the 1D contour will differ according to the size of the object as depicted in the image. In contrast, if the predetermined distance is a global distance, moving a predetermined distance along the 1D contour will result in identification of the same points along the 1D contour irrespective of whether the object was close to, or further away, from the image capture device.

As described above, in various examples, instead of using distance (which may be a real world distance) the data points that are related to the selected data point may be selected using other criteria. In various examples they may be selected based on a real world (or global) measurement unit which may be a real world distance (e.g. in terms of millimeters or centimeters), a real world angular difference (e.g. in terms of degrees or radians), etc.

Once the two points have been identified the classifier engine 214 determines a difference between contour-based features of these two data points (s+u₁ and s+u₂). The difference may be an absolute difference or any other suitable difference parameter based on the data used for each data point. It is then the difference data that is used by the classifier to classify the selected data point. In various examples, the difference between contour-based features of the two data points may be a distance between the two points projected onto one of the x, y or z-axes, a Euclidean distance between the two points, an angular distance between the two points, etc. The contour-based features used (e.g. position of the contour point in space, angular orientation of the 1D contour at the contour point, etc.) may be independent of the method used to select data points, (e.g. an angular distance may be used as the difference between contour-based features of the two data points irrespective of whether the two points were identified based on a distance or an angle). In other examples where IMU data is used, acceleration may be used as a contour-based feature (where acceleration may be one of the parameters stored for each data point or may be inferred from other stored information such as velocities).

In some cases the classifier is a random decision forest. However, it will be evident to a person of skill in the art that other classifiers may also be used, such as Support Vector Machines (SVMs).

Once the selected data point has been classified the method 400 proceeds to block 408.

At block 408, the classifier engine 214 stores the classification data generated in block 406. As described above the classification data may include one or more labels and probability information associated with each label indicating the likelihood the label is correct. Once the classification data for the selected data point has been stored, the method 400 proceeds to block 410.

At block 410 the classifier engine 214 determines whether there are more data points of the received 1D contour to be classified. Where the classifier engine 214 is configured to classify each data point of the 1D contour then the classifier may determine that there are more data points to be classified if not all of the data points have been classified. Where the classifier engine 214 is configured to classify only a subset of the data points of the 1D contour then the classifier engine 214 may determine there are more data points to be classified if there any unclassified data points that meet the classification criteria (the criteria used to determine which data points are to be classified). If the classifier engine 214 determines that there is at least one data point to be classified, the method 400 proceeds back to block 404. If, however, the classifier engine 214 determines that there are no data points left to be classified, the method proceeds to block 412.

At block 412, the classifier engine 214 aggregates the classification data for each classified data point to assign a final label or set of labels to the object. In some examples, the classification data for a (proper) subset of the classified data points may be aggregated to provide a classification for a first part of the object and the classification data for a non-overlapping (proper) subset of the classified data points may be aggregated to provide a classification for a second part of the object, etc.

As described above, in some examples the object is a hand and the goal of the classifier to assign: (i) a state label to the hand indicating the position of the hand; and (ii) one or more part labels to portions of the hand to identify parts of the hand. In these examples, the classifier engine 214 may determine the final state of the hand by pooling the probability information for the state labels from the data point classifications to form a final set of state probabilities. This final set of probabilities is then used to assign a final state label. A similar two-label (or multi-label) approach to labeling may also be applied to other objects.

To determine the final part label(s) the classifier engine 214 may be configured to apply a one dimensional running mode filter to the data point part labels to filter out the noisy labels (i.e. the labels with probabilities below a certain threshold). The classifier engine 214 may then apply connected components to assign final labels to the fingers. In some cases the classifier engine 214 may select the point with the largest curvature within each component as the fingertip.

Once the classifier engine 214 has assigned a final label or set of labels to the object using the data point classification data, the method 400 proceeds to block 414.

At block 414, the classifier outputs the final label or set of labels (e.g. part and state label(s)). As described above the state and part labeling may be used to control an application running on the computing-based device 108.

In addition to, or instead of, outputting labels (at block 414), the classifier may also output quantitative information about the orientation of the object and this is dependent upon the information stored within the classifier engine. For example, where random decision forests are used, in addition to or instead of storing label data at each leaf node, quantitative information, such as the angle of orientation of a finger or the angle of rotation of an object, may be stored.

The object to which the one-dimensional contour relates and which is classified using the methods described herein may be a single item (e.g. a hand, a mug, etc.) or it may be a combination of items (e.g. a hand holding a pen or an object which has been partially occluded by another object). Where the 1D contour is of an object which is a combination of items, the object may be referred to as a composite object and the composite object may be classified as if it were a single object. Alternatively, the 1D contour may be processed prior to starting the classification process to split it into more than one 1D contour and one or more of these 1D contours may then be classified separately.

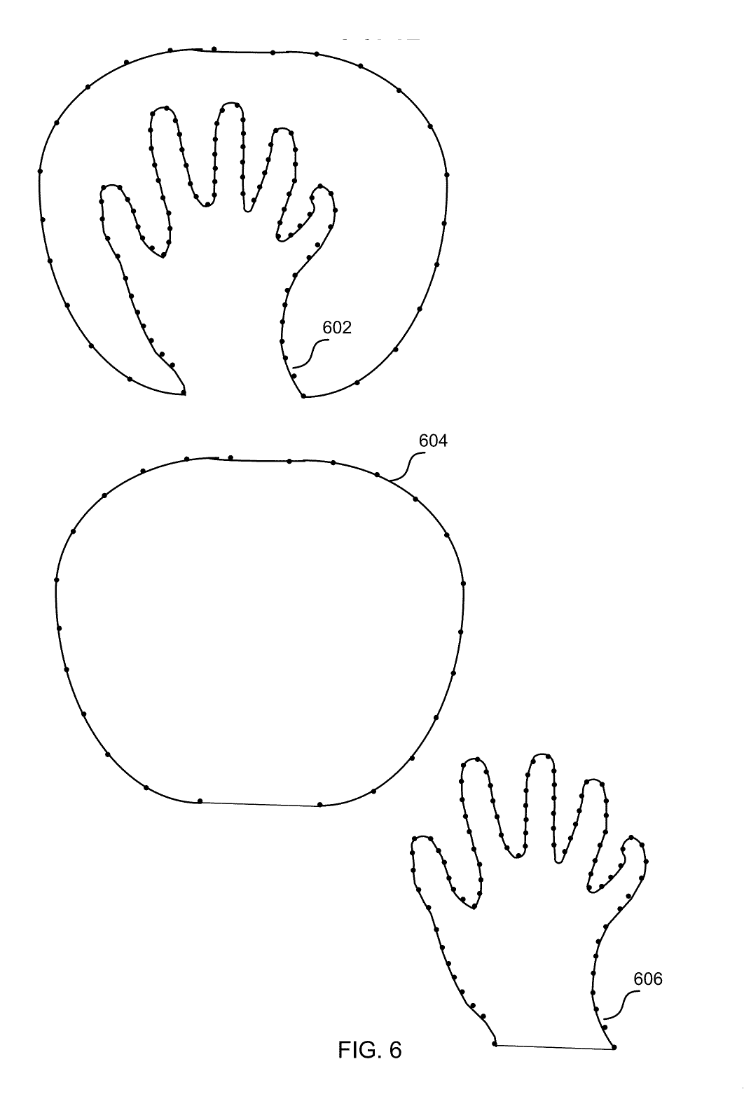

This is illustrated in FIG. 6 where the classifier engine 214 receives a 1D contour signal 602 for a retroreflector which is partially occluded by a hand. In such an example, the classifier engine 214 may be configured to estimate the convex hull 604 of the retroreflector and thereby generate two 1D contours, one 604 for the retroreflector and another 606 for the occluding object, which in this example is a hand.

By splitting the input 1D contour in this way, the classification process for each generated 1D contour may be simpler and the training process may be simpler as it reduces the possible variation in the 1D contour due to occlusion. As the 1D contours are much simpler in this case, much shallower forests may be sufficient for online training.

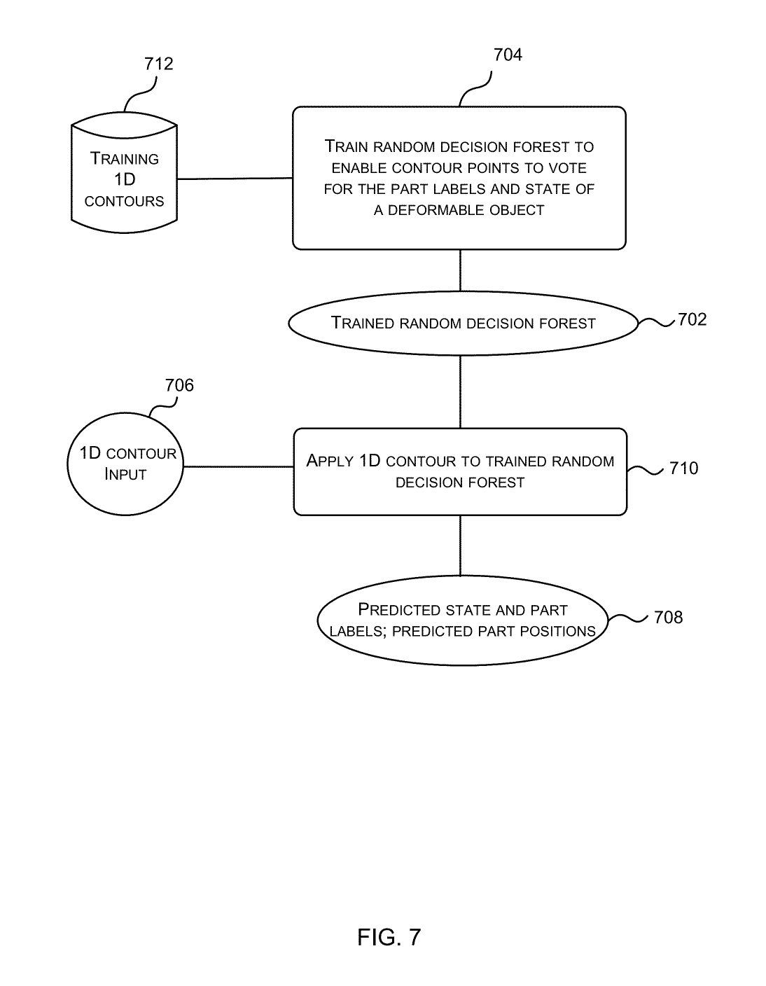

Reference is now made to FIG. 7 which illustrates an example method for classifying an object using a random decision forest 702. In this example the random decision forest 702 may be created and trained in an offline process 704 and may be stored at the computing-based device 108 or at any other entity in the system or elsewhere in communication with the computing-based device. The random decision forest 702 is trained to label points of a one-dimensional contour input signal 706 with both part and state labels 708 where part labels identify components of a deformable object, such as finger tips, palm, wrist, lips, laptop lid and where state labels identify configurations of an object, such as open, closed, spread, clenched or orientations of an object such as up, down. The random decision forest 702 provides both part and state labels in a fast, simple manner which is not computationally expensive and which may be performed in real time or near real time on a live video feed from the capture device 102 of FIG. 1 even using conventional computing hardware in a single-threaded implementation.

The state and part labels may be input to a gesture detection or recognition system which may simplify the gesture recognition system because of the nature of the inputs it works with. For example, the inputs enable some gestures to be recognized by looking for a particular object state for a predetermined number of images, or transitions between object states.

As mentioned above the random decision forest 702 may be trained 704 in an offline process using training contour signals 712.

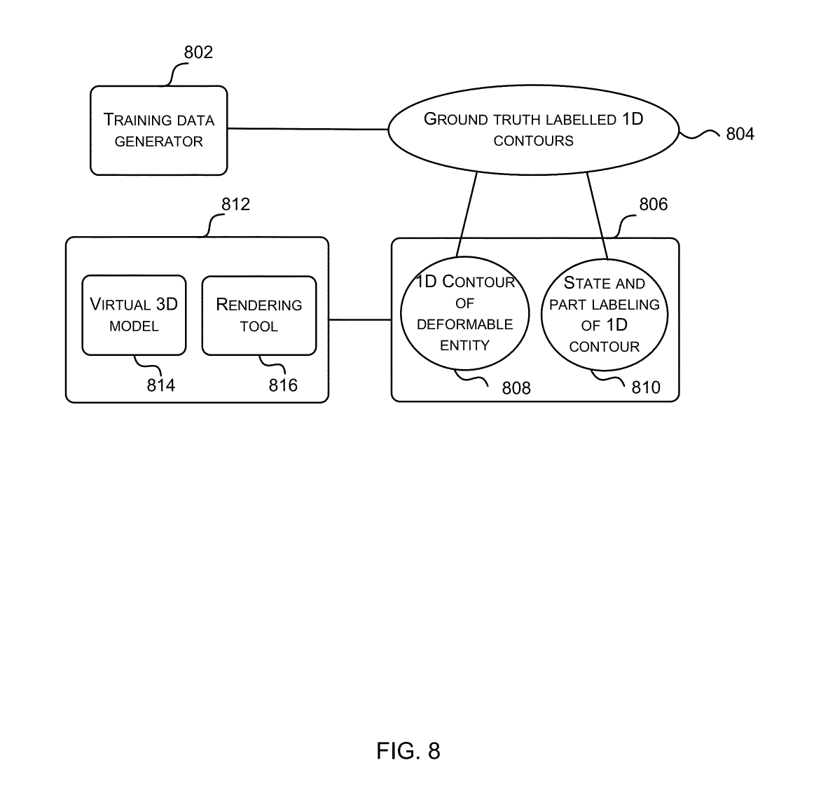

Reference is now made to FIG. 8 which illustrates a process for generating the training 1D contour signals. A training data generator 802, which is computer implemented, generates and scores ground truth labeled 1D contour signals 804 also referred to as training 1D contour signals. The ground truth labeled 1D contour signals 804 may comprises many pairs of 1D contour signals, each pair 806 comprising a 1D contour signal 808 of an object and a labeled version of that 1D contour signal 810 where each data point comprises a state label and relevant data points also comprise a part label. The objects represented by the 1D contour signals and the labels used may vary according to the application domain. The variety of examples in the training 1D contour signals of objects and configuration and orientations of those objects is as wide as possible according to the application domain, storage and computing resources available.

The pairs of training 1D contour signals 804 may be synthetically generated using computer graphics techniques. For example, a computer system 812 may have access to virtual 3D model 814 of an object and to a rendering tool 816. Using the virtual 3D model the rendering tool 816 may be arranged to automatically generate a plurality of high quality contour signals with labels. In some examples, where the object is a hand, the virtual 3D model may have 32 degrees of freedom which can be used to automatically pose the hand in a range of parameters. In some examples, synthetic noise is added to rendered contour signals to more closely replicate real world conditions. In particular, synthetic noise may be added to one or more hand joint angles.

Where the object is a hand, the rendering tool 816 may first generate a high number (in some cases this may be as high as 8,000) of left-hand 1D contour signals for each possible hand state. These may then be mirrored and given right hand labels. In these examples, the fingertips may be labeled by mapping the model with a texture that signifies different regions with separate colors. The training data may also include 1D contour signals generated from images of real hands and which have been manually labeled.

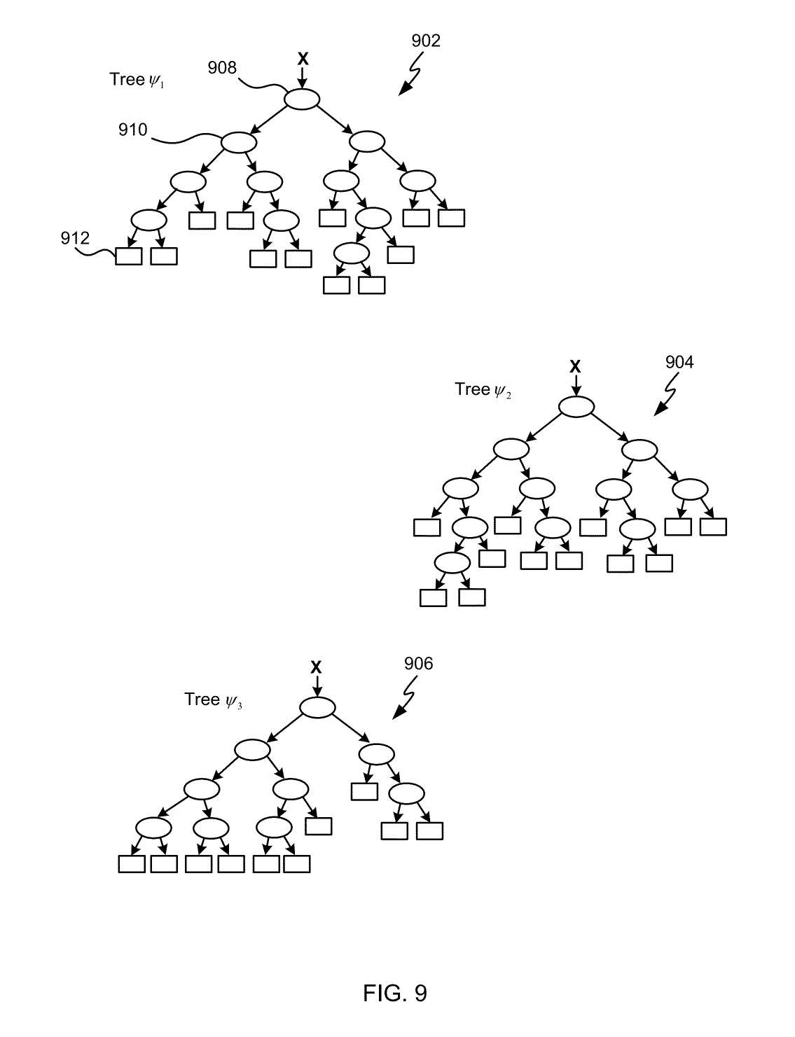

Reference is now made to FIG. 9 which is a schematic diagram of a random decision forest comprising three random decision trees 902, 904 and 906. One or more random decision trees may be used. Three are shown in this example for clarity. A random decision tree is a type of data structure used to store data accumulated during a training phase so that it may be used to make predictions about examples previously unseen by the random decision tree. A random decision tree is usually used as part of an ensemble of random decision trees (referred to as a forest) trained for a particular application domain in order to achieve generalization (that is being able to make good predictions about examples which are unlike those used to train the forest). A random decision tree has a root node 908, a plurality of split nodes 910 and a plurality of leaf nodes 912. During training the structure of the tree (the number of nodes and how they are connected) is learned as well as split functions to be used at each of the split nodes. In addition, data is accumulated at the leaf nodes during training.

In the examples described herein the random decision forest is trained to label (or classify) points of a 1D contour signal of an object in an image with part and/or state labels.

Data points of a 1D contour signal may be pushed through trees of a random decision forest from the root to a leaf node in a process whereby a decision is made at each split node. The decision is made according to characteristics of the data point being classified and characteristics of 1D contour data points displaced from the original data point by spatial offsets specified by the parameters of the split node. For example, the test function at split nodes may be of the form shown in equation (1):

f(F)<T (1)

where the function f maps the features F of the data point.

An exemplary test function is shown in equation (2):

f(s,u₁,u₂,\vec{p})=[X(s+u₂)−X(s+u₂)]_{\vec{p}} (2)

where s is the data point being classified, u₁ is a first fixed distance from point s, u₂ is a second predetermined distance from point s, [ ]_{\vec{p}} is a projection on to the vector \vec{p}, and \vec{p} is one of the primary axes \vec{x}, \vec{y}, or \vec{z}. This test probes two offsets (s+u₁ and s+u₂) on the 1D contour, gets their world distance in one direction, and this distance is compared against the threshold T. The test function splits the data into two sets and sends them each to a child node.

At a split node the data point proceeds to the next level of the tree down a branch chosen according to the results of the decision. During training, parameter values (also referred to as features) are learnt for use at the split nodes and data comprising part and state label votes are accumulated at the leaf nodes.

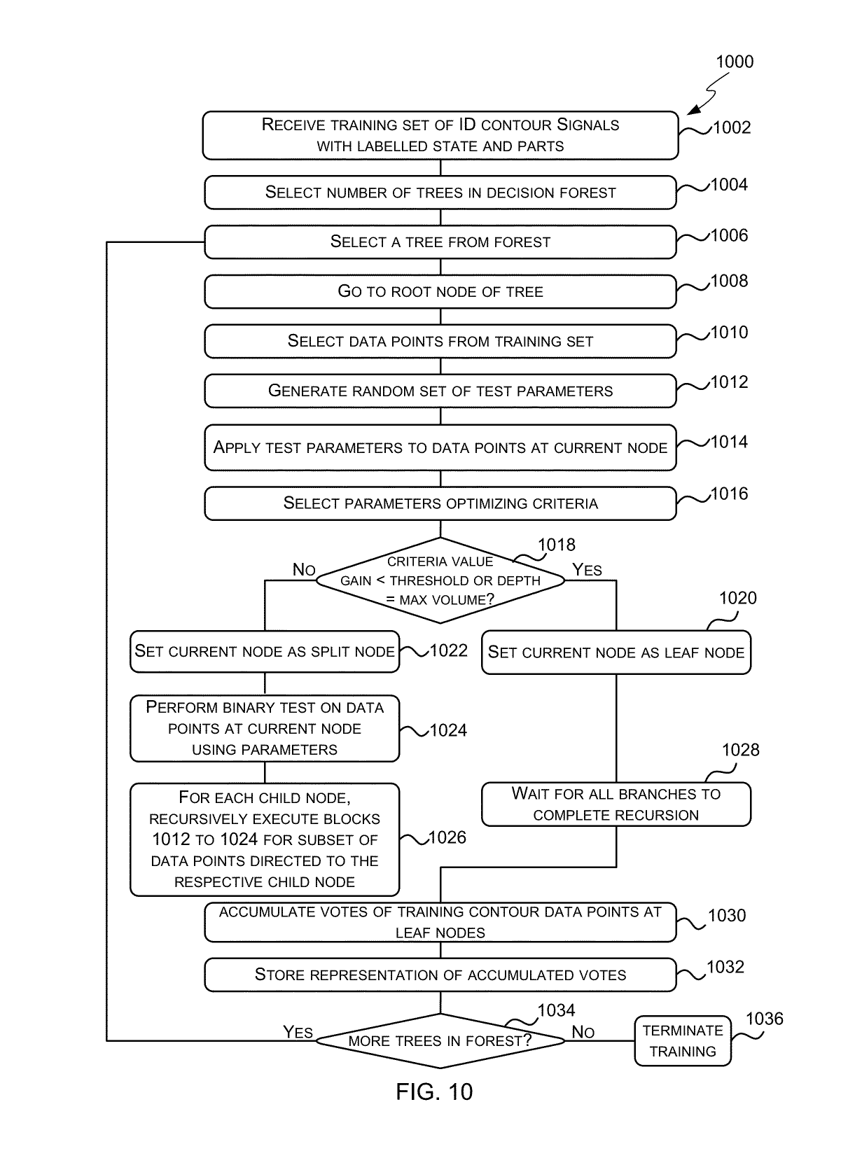

Reference is now made to FIG. 10 will illustrates a flow chart of a method 1000 for training a random decision forest to assign part and state labels to data points of a 1D contour signal. This can also be thought of as generating part and state label votes for data points of a 1D contour signal (i.e. each data point votes for a particular part label and a particular state label). The random decision forest is trained using a set of training 1D contour signals as described above with reference to FIG. 7.

At block 1002 the training set of 1D contour signals as described above is received. Once the training set of 1D contour signals has been received, the method 900 proceeds to block 1004.

At block 1004, the number of decision trees to be used in the random decision forest is selected. As described above a random decision forest is a collection of deterministic decision trees. Decision trees can sometimes suffer from over-fitting, i.e. poor generalization. However, an ensemble of many randomly trained decision trees (a random forest) can yield improved generalization. Each tree of the forest is trained. During the training process the number of trees is fixed. Once the number of decision trees has been selected, the method 1000 proceeds to block 1006.

At block 1006, a tree from the forest is selected for training Once a tree has been selected for training, the method 1000 proceeds to block 1008.

At block 1008, the root node of the tree selected in block 1006 is selected. Once the root node has been selected, the method 1000 proceeds to block 1010.

At block 1010, at least a subset of the data points form each training 1D contour signal is selected for training the tree. Once the data points from the training 1D contour signals to be used for training have been selected, the method 1000 proceeds to block 1012.

At block 1012, a random set of test parameters are then used for the binary test performed at the root node as candidate features. In operation, each root and split node of each tree performs a binary test on the input data and based on the results directs the data to the left or right child node. The leaf nodes do not perform any action; they store accumulated part and state label votes (and optionally other information). For example, probability distributions may be stored representing the accumulated votes.

In one example the binary test performed at the root node is of the form shown in equation (1). Specifically, a function f (F) evaluates a feature F of a data point s to determine if it is greater than a threshold value T. If the function is greater than the threshold value then the result of the binary test is true. Otherwise the result of the binary test is false.

It will be evident to a person of skill in the art that the binary test of equation (1) is an example only and other suitable binary tests may be used. In particular, in another example, the binary test performed at the root node may evaluate the function to determine if it is greater than a first threshold value T and less than a second threshold value T.

A candidate function f(F) can only make use of data point information which is available at test time. The parameter F for the function f(F) is randomly generated during training. The process for generating the parameter F can comprise generating random distances u₁ and u₂ along the contour, and choosing a random dimension x, y, or z. The result of the function f (F) is then computed as described above. The threshold value T turns the continuous signal into a binary decision (branch left/right) that provides some discrimination between the part and state labels of interest.

For example, as described above, the function shown in equation (2) above may be used as the basis of the binary test. This function determines the distance between two data points spatially offset along the 1D contours from the data point of interest s by distances u₁ and u₂ respectively and maps this distance onto p, where p one of the primary axes x, y and z. As described above, u₁ and u₂ may be normalized (i.e. defined in terms of real world distances) to make u₁ and u₂ scale invariant.

The random set of test parameters comprises a plurality of random values for the function parameter F and the threshold value T. For example, where the function of equation (2) is used, a plurality of random values for u₁, u₂, p and T are generated. In order to inject randomness into the decision trees, the function parameters F of each split node are optimized only over a randomly sampled subset of all possible parameters. This is an effective and simple way of injecting randomness into the trees, and increased generalization.

It should be noted that different features of a data point may be used at different nodes. In particular, the same type of binary test function may not be used at each node. For example, instead of determining the distance between two data points with respect to an axis (i.e. x, y or z) the binary test may evaluate the Euclidian distance, angular distance, orientation distance, difference in time, or any other suitable feature of the contour.

Once the test parameters have been selected, the method 1000 proceeds to block 1014.

At block 1014, every randomly chosen combination of test parameters is applied to each data point selected for training. In other words, available values for F (i.e. u₁, u₂, p) in combination with available values of T for each data point selected for training. Once the combinations of test parameters are applied to the training data points, the method 1000 proceeds to block 1016.

At block 1016, optimizing criteria are calculated for each combination of test parameters. In an example, the calculated criteria comprise the information gain (also known as the relative entropy) of the histogram or histograms over parts and states. Where the test function of equation (2) is used, the gain G of a particular combination of test parameters may be calculated using equation (3):

$$G ( {u}_{1} , {u}_{2} , T ) = G ( C ) - {\sum }_{s ∈ \{ L , R \}}^{ } \frac{\vert {C}_{s} \vert}{\vert C \vert} H ( {C}_{s} ) \qquad ( 3 )$$

where H(C) is the Shannon Entropy of the class label distribution of the labels y (e.g. y^{f} and y^{s}) in the sample set C, and C_{L}, and C_{R} are the two sets of examples formed by the split.

In some examples, to train a single forest that jointly handles shape classification and part localization (e.g. fingertip localization), the part labels (e.g. y^{f}) may be disregarded when calculating the gain until a certain depth m in the tree is reached so that up to this depth m the gain is only calculated using the state labels (e.g. y^{s}). From that depth m on, the state labels (e.g. y^{s}) may be disregarded when calculating the gain so the gain is only calculated using the part labels (e.g. y^{f}). This has the effect of conditioning each subtree that starts at depth m to the shape class distributions at their roots. This conditions low level features on the high level feature distribution. In other examples, the gain may be mixed or may alternate between parts and state labels.

Other criteria that may be used to assess the quality of the parameters include, but is not limited to, Gini entropy or the ‘two-ing’ criterion. The parameters that maximized the criteria (e.g. gain) is selected and stored at the current node for future use. Once a parameter set has been selected, the method 1000 proceeds to block 1018.

At block 1018, it is determined whether the value for the calculated criteria (e.g. gain) is less than (or greater than) a threshold. If the value for the criteria is less than the threshold, then this indicates that further expansion of the tree does not provide significant benefit. This gives rise to asymmetrical trees which naturally stop growing when no further nodes are beneficial. In such cases, the method 1000 proceeds to block 1020 where the current node is set as a leaf node. Similarly, the current depth of the tress is determined (i.e. how many levels of nodes are between the root node and the current node). If this is greater than a predefined maximum value, then the method 1000 proceeds to block 1020 where the current node is set as a leaf node. In some examples, each leaf node has part and state label votes which accumulate at that leaf node during the training process as described below. Once the current node is set to the leaf node, the method 1000 proceeds to block 1028.

If the value for the calculated criteria (e.g. gain) is greater than or equal to the threshold, and the tree depth is less than the maximum value, then the method 1000 proceeds to block 1022 where the current node is set to a split node. Once the current node is set to a split node the method 1000 moves to block 1024.

At block 1024, the subset of data points sent to each child node of the split nodes is determined using the parameters that optimized the criteria (e.g. gain). Specifically, these parameters are used in the binary test and the binary test is performed on all the training data points. The data points that pass the binary test form a first subset sent to a first child node, and the data points that fail the binary test form a second subset sent to a second child node. Once the subsets of data points have been determined, the method 1000 proceeds to block 1026.

At block 1026, for each of the child nodes, the process outlined in blocks 1012 to 1024 is recursively executed for the subset of data points directed to the respective child node. In other words, for each child node, new random test parameters are generated, applied to the respective subset of data points, parameters optimizing the criteria selected and the type of node (split or leaf) is determined. Therefore, this process recursively moves through the tree, training each node until leaf nodes are reached at each branch.

At block 1028, it is determined whether all nodes in all branches have been trained. Once all nodes in all branches have been trained, the method 1000 proceeds to block 1030.

At block 1030, votes may be accumulated at the leaf nodes of the trees. The votes comprise additional counts for the parts and the states in the histogram or histograms over parts and states. This is the training stage and so particular data points which reach a given leaf node have specified part and state level votes known from the ground truth training data. Once the votes are accumulated, the method 1000 proceeds to block 1032.

At block 1032, a representation of the accumulated votes may be stored using various different methods. The histograms may be of a small fixed dimension so that storing the histograms is possible with a low memory footprint. Once the accumulated votes have been stored, the method 1000 proceeds to block 1034.

At block 1034, it is determined whether more trees are present in the decision forest. If so, then the method 1000 proceeds to block 1006 where the next tree in the decision forest is selected and the process repeats. If all the trees in the forest have been trained, and no others remain, then the training process is complete and the method 1000 terminates at block 1036.

Reference is now made to FIG. 11 which illustrates an example method 1100 for classifying a data point in a 1D contour signal using a decision tree forest (e.g. as in block 710 of FIG. 7). The method 1100 may be executed by the classifier engine 214 at block 406 of FIG. 4. Although the method 1100 is described as being executed by the classifier engine 214 of FIG. 2, in other examples all or part of the method may be executed by another component of the system described herein.

At block 1102 the classifier engine 214 receives a 1D contour signal data point to be classified. As described above, in some examples the classifier engine 214 may be configured to classify each data point of a 1D contour signal. In other examples the classifier engine 214 may be configured to classify only a subset of the data points of a 1D contour signal. In these examples, the classifier engine 214 may use a predetermined set of criteria for selecting the data points to be classified. Once the classifier engine receives a data point to be classified the method 1100 proceeds to blocks 1104.

At block 1104, the classifier engine 214 selects a decision tree from the decision forest. Once a decision tree has been selected, the method 1100 proceeds to block 1106.

At block 1106, the classifier engine 214 pushes the contour data point through the decision tree selected in block 1104, such that it is tested against the trained parameters at a node, and then passed to the appropriate child in dependence on the outcome of the test, and the process repeated until the image element reaches a leaf node. Once the data point reaches a leaf node, the method 1100 proceeds to block 1108.

At block 1108, the classifier engine 214 stores the accumulated part and state label votes associated with the end leaf node. The part and state label votes may be in the form of a histogram or any other suitable form. In some examples there is a single histogram that includes votes for part and state. In other examples there is one histogram that includes votes for a part and another histogram that includes votes for a state. Once the accumulated part and state label votes are stored the method 1100 proceeds to block 1110.

At block 1110, the classifier engine 214 determines whether there are more decision trees in the forest. If it is determined that there are more decision trees in the forest then the method 1100 proceeds back to block 1104 where another decision tree is selected. This is repeated until it has been performed for all the decision trees in the forest and then the method ends 1112. Note that the process for pushing an image element through the plurality of tress in the decision forest may be performed in parallel, instead of in sequence as shown in FIG. 11.

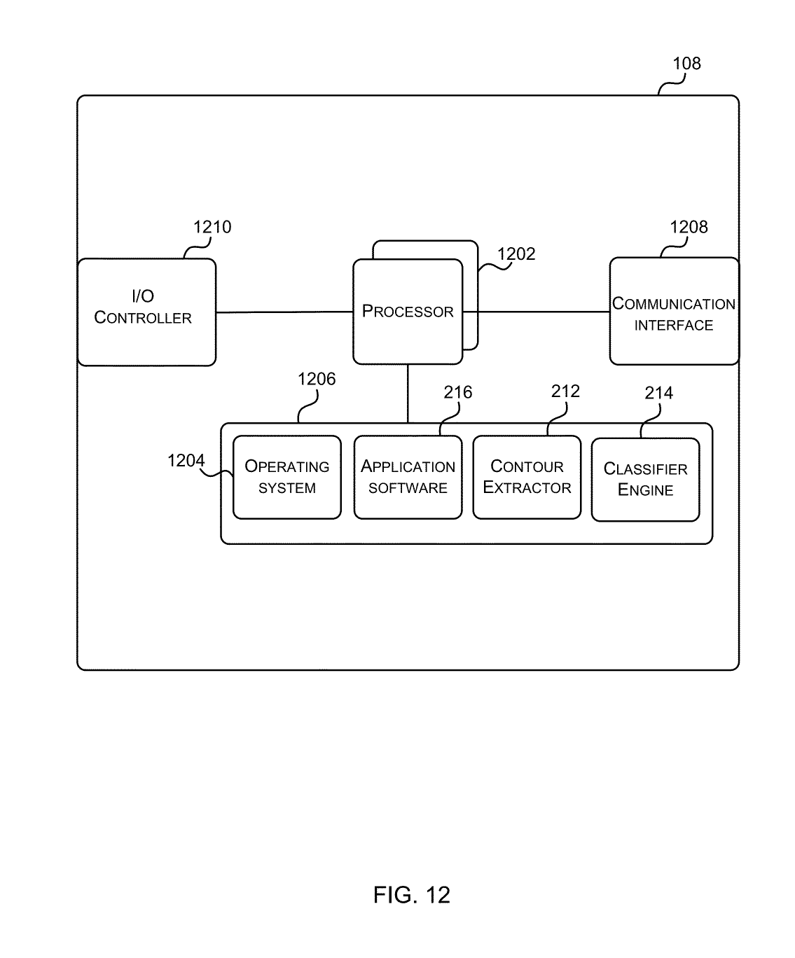

FIG. 12 illustrates various components of an exemplary computing-based device 108 which may be implemented as any form of a computing and/or electronic device, and in which embodiments of the systems and methods described herein may be implemented.

Computing-based device 108 comprises one or more processors 1202 which may be microprocessors, controllers or any other suitable type of processors for processing computer executable instructions to control the operation of the device in order to classify objects in image. In some examples, for example where a system on a chip architecture is used, the processors 1202 may include one or more fixed function blocks (also referred to as accelerators) which implement a part of the method of controlling the computing-based device in hardware (rather than software or firmware). Platform software comprising an operating system 1004 or any other suitable platform software may be provided at the computing-based device to enable application software 216 to be executed on the device.

The computer executable instructions may be provided using any computer-readable media that is accessible by computing based device 108. Computer-readable media may include, for example, computer storage media such as memory 1206 and communications media. Computer storage media, such as memory 1206, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing-based device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 1206) is shown within the computing-based device 108 it will be appreciated that the storage may be distributed or located remotely and accessed via a network or other communication link (e.g. using communication interface 1208).

The computing-based device 108 also comprises an input/output controller 1210 arranged to output display information to a display device 110 (FIG. 1) which may be separate from or integral to the computing-based device 108. The display information may provide a graphical user interface. The input/output controller 1210 is also arranged to receive and process input from one or more devices, such as a user input device (e.g. a mouse, keyboard, camera, microphone or other sensor). In some examples the user input device may detect voice input, user gestures or other user actions and may provide a natural user interface (NUI). In an embodiment the display device 110 may also act as the user input device if it is a touch sensitive display device. The input/output controller 1010 may also output data to devices other than the display device, e.g. a locally connected printing device (not shown in FIG. 12).

The input/output controller 1210, display device 110 and optionally the user input device (not shown) may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method of classifying an item, the method comprising:
receiving at a computing-based device a one-dimensional (1D) contour signal for the item, the one-dimensional contour signal comprising a series of data points that defines the item;
applying a classifier to at least a portion of the data points to classify each data point of the portion of data points using contour-based features; and
aggregating the classification of the portion of data points to classify the item.

2. The method according to claim 1, wherein applying the classifier to a particular data point comprises identifying a data point spatially offset from the particular data point and determining a difference between the identified data point and another data point.

3. The method according to claim 2, wherein the other data point is the particular data point.

4. The method according to claim 2, wherein the other data point is spatially offset from the particular data point.

5. The method according to claim 2, wherein the identified data point is a predetermined real world measurement unit along the 1D contour from the particular data point.

6. The method according to claim 2, wherein the identified data point is a predetermined angle from the particular data point.

7. The method according to claim 2, wherein the difference between the identified data point and the other data point represents a real world distance between the identified data point and the other data point.

8. The method according to claim 2, wherein the difference between the identified data point and the other data point represents a real world distance between the identified data point and the other data point projected onto a predefined axis.

9. The method according to claim 1, further comprising, prior to applying the classifier to at least a portion of the data points, re-sampling the received 1D contour signal to generate a modified 1D contour signal, the modified 1D contour signal comprising a series of data points along the 1D contour of the object wherein each data point is a predetermined real world distance along the 1D contour from the next data point in the modified 1D contour signal.

10. The method according to claim 1, wherein the classifier classifies each data point of the portion of data points as being part of at least one of a particular part and a particular state.

11. The method according to claim 11, wherein the classifier produces classification data for each data point of the portion of data points, the classification data indicating the probability that the data point is part of each of a plurality of possible parts and each of a plurality of possible states.

12. The method according to claim 1, further comprising:
estimating a convex hull of the item based on the contour signal;
generating a simplified contour signal for the estimated convex hull, the simplified contour signal comprising a plurality of data points; and
applying the classifier to the data points of the simplified contour signal.

13. The method according to claim 1, wherein each data point is a three-dimensional data point.

14. The method according to claim 1, wherein the classifier is a random decision forest.

15. The method according to claim 1, wherein the item is a physical object.

16. The method according to claim 1, wherein the 1D contour signal is generated from one or more images depicting the item.

17. The method according to claim 16, wherein the item is a physical object and the one or more images each depict a silhouette of the object.

18. A system to classify an item, the system comprising:
a computing-based device configured to:
receive a one-dimensional contour signal for the item, the one-dimensional contour signal comprising a series of data points that defines the item;
applying a classifier to at least a portion of the data points to classify each data point of the portion of data points using contour-based features; and
aggregating the classification of the data points to classify the item.

19. The system according to claim 18, the computing-based device being at least partially implemented using hardware logic selected from any one of more of: a field-programmable gate array, a program-specific integrated circuit, a program-specific standard product, a system-on-a-chip, a complex programmable logic device.

20. A method of classifying an object depicted in an image, the method comprising:
receiving at a computing-based device a one-dimensional contour signal for the object, the one dimensional contour signal comprising a series of data points along an outline of the object, each data point being a three-dimensional data point indicating the location of the data point in world space;
applying a classifier to at least a portion of the data points to classify each data point of the portion of data points; and
aggregating the classification of the data points to classify the object.
